(19) United States
(12) Patent Application Publication
(10) Pub. No.: US 2008/0091498 A1
(43) Pub. Date: Apr. 17, 2008

(54) METHOD OF OPTIMIZING A WORKFORCE THROUGH THE IDENTIFICATION AND SEGMENTATION OF RESOURCES AND JOB TASKS

(76) Inventors: Michael Darren Chiverton, Wingdale, NY (US); John Albert Dell' Arciprete, Raleigh, NC (US); Paul John Hardisty, Beacon, NY (US); Mark A. Henderson, Cornwall, NY (US); Geri Dee McGrath, Cary, NC (US); Nicholas Louis Volkringer, Southbury, CT (US)

Correspondence Address: DUKE W. YEE;YEE & ASSOCIATES, P.C., P.O. BOX 802333, DALLAS, TX, 75380, US

(21) Appl. No.: 11/537,057

(22) Filed: Sep. 29, 2006

(51) Int. Cl. G06F 15/02

(52) U.S. Cl. 705/9

(57) ABSTRACT

A method, data processing system, and computer usable program code are provided for optimizing a workforce for a company. An organizational development structure and an optimization performance structure are identified. A set of functional strategy tasks are developed using the organizational development structure and the optimization performance structure. An inventory of current tasks and skills within the company is performed, and tasks and skills from the current inventory of tasks and skills that are associated with the set of functional strategy tasks are identified to form a set of identified tasks and skills. A set of skill gaps are then identified using the set of identified tasks and skills.

### BACKGROUND OF THE INVENTION

1. Field of the Invention

The present invention relates generally to workforce management. More particularly, the present invention relates to a method of optimizing a workforce through the identification and segmentation of resources and job tasks in support of a globally integrated environment.

2. Description of the Related Art

Workforce management (WFM) is the process of having the right number of skilled people, and supporting resources, in the right place at the right time to meet the desired service levels for an accurately forecasted workload.

Workforce management removes the guesswork from planning by carefully balancing the demands of business activities, staff requirements, and customers' service level expectations with efficient staffing levels.

Poor workforce management can result in overstaffing or understaffing, both of which can be harmful to a business. Overstaffing is costly and can erode profit margins, while understaffing results in inferior customer service, which can be damaging. Understaffing is also bad for employee morale, leading to high advisor attrition rates and increased recruitment costs.

As part of workforce management, managers and team leaders spend a significant amount of time of every working week devoted to employee scheduling issues. Many companies still use spreadsheets to manage their advisors' time. These systems are not sufficiently flexible to deal with the increasing complexity of today's company's requirements, such as multi-skills and multi-tasks, advisor work requirements and customer service expectations. Spreadsheets do not have the functionality to absorb all of the information within network systems or email systems. Spreadsheets cannot forecast workloads with any sophisticated methodology, allow for customer contact trends, or formulate schedules, taking into account agent contracts, work rules preferences, schedule equity and the important issue of agent optimization, which accounts for the best mix of shift durations and patterns.

Offering superior levels of customer service, while at the same time reducing costs and increasing revenues, is the biggest challenge facing organizations today. Workforce management allows businesses to deal with the increasing complexity of their customer interactions and to manage their employees more effectively, as they strive to increase growth and improve competitive advantage.

Thus, current workforce management is an ad-hoc, inconsistent set of activities which vary dramatically from organization to organization and geography to geography. Current workforce management solutions impact global reach, client responsiveness, long-term hiring efficiency, and short-term hiring effectiveness.

### BRIEF SUMMARY OF THE INVENTION

The different aspects of the illustrative embodiments provide a computer implemented method, apparatus, data processing system, and computer usable program code for optimizing a workforce for a company. The illustrative embodiments identify an organizational_development structure and an optimization performance structure. The illustrative embodiments develop a set of functional strategy tasks using the organizational development structure and the optimization performance structure. The illustrative embodiments perform an inventory of current tasks and skills within the company and identify those tasks and skills from the current inventory of tasks and skills that are associated with the set of functional strategy tasks in order to form a set of identified tasks and skills. The illustrative embodiments identify a set of skill gaps using the set of identified tasks and skills.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 illustrates four steps of a process to create a workforce management strategy in accordance with an illustrative embodiment;

FIG. 2 highlights the business problem matrix in accordance with an illustrative embodiment;

FIG. 3 illustrates a flow diagram of the process used to create a workforce management strategy in accordance with an illustrative embodiment; and

FIG. 4 depicts a design system in accordance with an advantageous embodiment of the present invention.

### DETAILED DESCRIPTION OF THE INVENTION

The illustrative embodiments provide for optimizing a workforce through the identification and segmentation of resources and job tasks. The illustrative embodiments create a repeatable, robust methodology to identify and implement the optimal workforce to accomplish an organization's goals. The purpose of this methodology is to improve workforce flexibility, position the organization for growth, and leverage the global environment for balancing the supply and demand of key skills.

The advantages of utilizing this process include the optimization of an organization's worldwide workforce pool in the areas of flexibility, skill balancing, effective hiring, cost, and availability to market. It is a consistent, repeatable process which all product and/or service organizations in all geographies can utilize for workforce optimization. The process encourages evaluation based on financial and non-financial attributes. These attributes include workforce flexibility/variability, workforce efficiency/effectiveness, skills management/refinement, and cost optimization.

The process described in the illustrative embodiments is based on the establishment of a baseline of current workforce data. From this baseline, the evaluation of core functions and/or skill areas is performed based on a set of strategic questions. This evaluation determines the workforce optimization opportunities and the initial roadmap to pursue. The final action is to develop the deployment plans and track the progress toward the stated objectives. The deployment plan defines the areas or resources in which an organization will invest in, divest of, or provide retraining for.

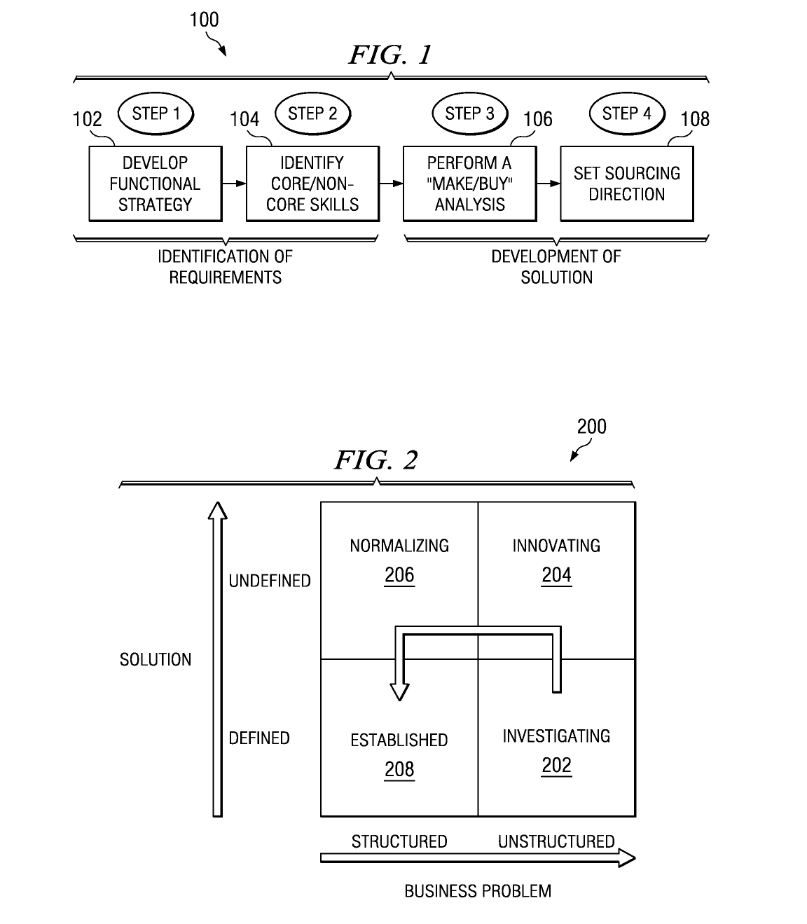

FIG. 1 illustrates four steps of a process to create a workforce management strategy in accordance with an illustrative embodiment. Workforce management strategy 100 is comprised of four steps: Develop Functional Strategy 102, Identify Core/Non-Core Skills 104, Perform a “Make/Buy” Analysis 106, and Set Sourcing Direction 108. The illustrative embodiments are embedded in the tight linkage across all four steps and are dependent on information flow into and out of each element of the end-to-end methodology. As part of the process flow, checkpoints are present to provide robustness and structure to the process activity.

In step 1, Develop Functional Strategy 104 provides the development of a functional strategy that is linked to the overall enterprise strategy. The functional strategy development is a two-pronged approach which focuses on an organizational development aspect as well as an optimized performance aspect. Balancing these two efforts is the key to establishing a strong, clearly-defined baseline for a workforce management methodology.

The organizational development aspect focuses on increasing the overall horizontal and vertical integration, increasing the environmental sensing capability, increasing an organization's flexibility in options of missions and services, and refocusing from client focused to client driven. The other side of the scale is the optimization of performance aspect. Optimization of performance is built around flexibility and cost, leveraging of skills and information, optimized execution, such as reliability, responsiveness, efficiency, and compliancy, superior customer experience, and best of breed competitiveness.

Accomplishing a healthy balance between the two aspects of a functional strategy requires that an organization focus on leveraging a worldwide workforce as well as on opening up the culture to drive partnering across functions in order to create a full spectrum of practitioners. The above items lead to the development of a functional strategy which can efficiently and quickly provide the core structure for skill identification for workforce management.

In step 2, Identify Core/Non-Core Skills 104 initial actions in identifying core/non-core skills is to inventory current tasks and the skills required to accomplish these tasks. The inventory of the tasks and skills may be performed by a survey of company employees to identify tasks, with a database provided by the company, or the like. The second action is to identify the task and skill requirements associated with the functional strategy and the emerging growth skill areas of the function. These emerging growth skill areas may currently be small or non-existent in today's business environment but may become key requirements in the coming years.

The next action is to identify skill gaps between current requirements and what may be needed in the future. A skill gap analysis compares the currently required skills with the skills expected to be required for the job in the future in order to identify future improvement opportunities. Identifying skill gaps allows the organization to assess the right mix of skills and workforce type such as regular, contractor, vendor, etc. Following identification of these skill gaps, consideration of gap closure actions is required. Gap closure actions are actions that may be taken to reach the future requirements, such as acquisition, hiring, redeployment, and skill development along with the timeframe, closure rate, and geographical area tied to each item.

One of the key aspects in determining skill area placement is the identification of core skills. Skills or job tasks can be identified as normalizing, established, investigating, or innovating. These descriptors correspond smoothly to a 2×2 matrix based on the business problem at hand as well as the solution identification. The value of breaking out the core tasks from the non-core tasks is to understand tasks that can be remote. Core tasks reflect the need to be close to a part of the business demanding face-to-face interaction with either an internal operation, a supplier base or customer location.

FIG. 2 highlights the business problem matrix in accordance with an illustrative embodiment. In FIG. 2, matrix 200 includes investigating area 202, innovating area 204, normalizing area 206, and established area 208. If a skill or task falls in investigating area 202, then a solution is defined for the result, but the process to achieve the result is unstructured. If a skill or task falls in innovating area 204, then a solution is undefined for the result, and the process to achieve the result is unstructured. If a skill or task falls in normalizing area 206, then a solution is undefined for the result, but the process to achieve the result is structured. If a skill or task falls in established area 208, then a solution is defined for the result, and the process to achieve the result is structured. A company desires for all skills and tasks to fall in established area 208.

The output of matrix 200 in FIG. 2 provides information on the current and future skill gaps, areas of decline, and what level of analysis is most meaningful and actionable for a particular function. By analyzing job skills or job categories against business problems, identification of core/non-core skills provides a sound baseline in the next step of the process—the make/buy analysis.

Returning to FIG. 1, in step 3, Perform a “Make/Buy” Analysis 106 accounts for several tangible and intangible elements for all skill groups using the make/buy decision process. These items include staffing requirements, such as long term, short term, seasonality, etc., competitive cost analysis, customer service improvement, and related missions being considered as part of the functional workforce management strategy.

Once the skill area being considered for optimization is identified, an analysis is conducted including financial and non-financial impacts. The financial assessment focuses on the total impact on the organization's after-tax earnings, cash flow and return-on-investment. The non-financial assessment looks at factors dependent on the characteristics of each specific decision. Within that assessment, a supply risk assessment on skills is needed, including a view of the market capabilities, labor relations issues, and training.

The output of the make/buy analysis process results in a clear identification of those tasks to be performed by the organization and those tasks to be out-sourced to outside providers or internally handled in low cost geographies. The process flow now directs the organization to the sourcing phase of the process methodology.

In step 4, Set Sourcing Direction 108 focuses on the interaction of the affected organizations and geographies with the workforce management optimization team. During the workforce evaluation process, these groups will work together to define the workforce management strategies and plans. In setting the sourcing direction, the initial aspect is to determine the conditions surrounding each task. The determination of the conditions can cover a variety of elements including the technical capabilities required, the level of on-site control needed, the determination of whether the task is customer facing, and the level of standardization of the task across the organization.

Secondly, the organization needs to assess capabilities within the countries being considered as part of the workforce management initiative. The assessment of capabilities includes understanding the organizational business requirements, the best practices of competitors who are sharing that country's landscape, and the identification of cities within the countries that are to be considered strategic for potential future resource growth. Within these cities, the organization must consider skilled workforce availability, and the city infrastructure and business environment, as well as the total overall cost of doing business in that city.

The third element of the process is the determination of the optimal geographical location, country and structure for each of the tasks considered within the workforce management initiative. The second element of Set Sourcing Direction 108 will provide a significant amount of the information necessary to make an informed decision.

The last task within Set Sourcing Direction 108 is to perform a detailed business case analysis and declare a sourcing direction for each of the tasks identified for movement.

Performing the detailed business case analysis and declaring a sourcing direction for each of the tasks identified for movement will require that the organization have a robust process in place which follows the traditional project management approach for implementation. As the implementation occurs, the strategy behind the activity as well as the activity itself will require communication from the stakeholders to the affected parties. The updated and approved workforce management strategy needs to be input to the organization's strategic planning process and communicated as appropriate. Using this input will allow for this updated strategy to drive the execution of the tactical planning process inside the organizational structure.

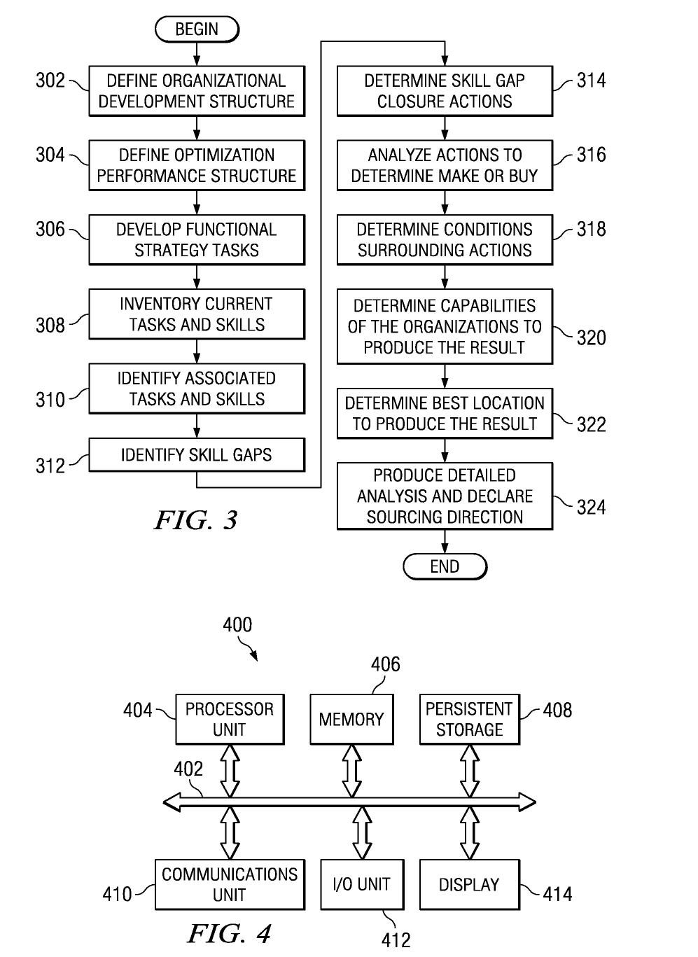

FIG. 3 illustrates a flow diagram of the process used to create a workforce management strategy in accordance with an illustrative embodiment.

As the process begins, an organizational development structure is defined that focuses on increasing overall horizontal and vertical integration, increasing environmental sensing capability, and increasing organizational flexibility (step 302). The organizational development structure is a strategic and inward-looking structure of the organization. The organization development structure focuses on organizational capability, understanding of the environment that the organization is operating in, and determination of how the organization will be operating going forward, such as client driven vs. client focused or flexible vs. rigid. Then, an optimization performance structure is defined around flexibility and cost, leveraging of skills and information, optimized execution, such as reliability, responsiveness, efficiency, and compliancy, superior customer experience, and best of breed competitiveness (step 304). The optimization performance structure is more tactical in nature. The optimization performance structure focuses on current performance and how to improve on this performance. The optimization performance structure takes into account cost, customer satisfaction, and the existing competitive environment. In simpler terms, the optimization performance structure identifies how well the organization executes. Once the organizational development structure and the optimization performance structure are defined, a functional strategy is developed that defines the tasks that are needed to meet the company's goals (step 306).

With the tasks identified to meet the company's functional strategy, an inventory is performed of the current tasks and skills that exist within the company (step 308). The key tasks to develop in a functional strategy would be to understand the corporate strategy, to understand the divisional strategy, to understand key corporate metrics, and to define a functional strategy which is aligned with the above aspects. One of the key aspects is to develop a balance between leverage of the worldwide workforce and the fostering of a partnering environment across functions to create a full spectrum of practitioners. This strategy needs to take into account the function's core mission including tasks performed and skills needed as well as the future functional mission based on the corporate strategy including the tasks performed and skills needed. Any task or skill that is associated with the company's functional strategy tasks are identified (step 310). Then, skill gaps are identified between the company's current tasks and skills and the company's functional strategy tasks (step 312). Once the skill gaps are identified, actions may be determined so that the skill gaps may be closed (step 314).

Using the determined actions, an analysis is made as to whether to make or buy the necessary items to complete the actions (step 316). A determination is then made of all the conditions surrounding each of the company's functional strategy tasks (step 318). The determination of the conditions may cover a variety of elements including the technical capabilities required, the level of on-site control needed, whether the task is customer facing, and how standardized the task is across the organization. Then, an assessment of the capability of the each organizational sector is performed (step 320). The assessment of the capabilities of each organizational sector includes understanding the organizational business requirements, the best practices of competitors who are sharing that country's landscape, and the identification of cities within the countries that are to be considered for resource growth. Within these cities, the organization must consider skilled workforce availability, and the city infrastructure and business environment, as well as the total overall cost of doing business in that city.

A determination is then made as to the best location to produce the desired result in order to meet the company's functional strategy tasks (step 322). Finally, a detailed business case analysis is produced and a sourcing direction is declared for each of the tasks identified for movement (step 324), with the process ending thereafter.

Thus, the illustrative embodiments provide for the means for optimizing a workforce for a company. An organizational development structure and an optimization performance structure are identified. A set of functional strategy tasks are identified using the organizational development structure and the optimization performance structure. An inventory of tasks and skills currently within the company is performed. Tasks and skills from the current tasks and skills that are associated with the set of functional strategy tasks are identified to form a set of identified tasks and skills. A set of skill gaps is then identified using the set of identified tasks and skills.

While the aspects described in the illustrative embodiments above are described as a manual process, the processes described may be implemented in a computer environment. FIG. 4 depicts a design system in accordance with an advantageous embodiment of the present invention. In this illustrative example, data processing system 400 includes communications fabric 402, which provides communications between processor unit 404, memory 406, persistent storage 408, communications unit 410, I/O unit 412, and display 414.

Processor unit 404 serves to execute instructions for software that may be loaded into memory 406. Processor unit 404 may be a set of one or more processors or may be a multi-processor core, depending on the particular implementation. Memory 406, in these examples, may be, for example, a random access memory. Persistent storage 408 may take various forms depending on the particular implementation. For example, persistent storage 408 may be, for example, a hard drive, a flash memory, a rewritable optical disk, a rewritable magnetic tape, or some combination of the above.

Communications unit 410, in these examples, provides for communications with other data processing systems or devices. In these examples, communications unit 410 is a network interface card. I/O unit 412 allows for input and output of data with other devices that may be connected to data processing system 400. For example, I/O unit 412 may provide a connection for user input though a keyboard and mouse. Further, I/O unit 412 may send output to a printer. Display 414 provides a mechanism to display information to a user.

Instructions for the operating system, the object-oriented programming system, and the applications or programs are located on persistent storage 408. These instructions may be loaded into memory 406 for execution by processor unit 404. The processes of the different embodiments may be performed by processor unit 404 using computer implemented instructions, which may be located in a memory, such as memory 406.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of optimizing a workforce for a company, the method comprising:
identifying an organizational development structure and an optimization performance structure;
developing a set of functional strategy tasks using the organizational development structure and the optimization performance structure;
performing an inventory of current tasks and skills within the company;
identifying tasks and skills from the inventory of current tasks and skills that are associated with the set of functional strategy tasks to form a set of identified tasks and skills; and
identifying a set of skill gaps using the set of identified tasks and skills.

2. The method of claim 1, further comprising:
determining a set of skill gap closure actions using the set of skill gaps; and
analyzing the set of skill gap closure actions to form an analysis.

3. The method of claim 2, further comprising:
responsive to the analysis indicating that a skill gap closure action within the set of skill gap closure actions should be addressed internally from the company, internally addressing the skill gap closure action.

4. The method of claim 2, further comprising:
responsive to the analysis indicating that a skill gap closure action within the set of skill gap closure actions should be addressed externally to the company, externally addressing the skill gap closure action.

5. The method of claim 2, further comprising:
determining a set of conditions surrounding the set of skill gap closure actions;
determining capabilities of an internal or external organization to address the set of skill gap closure actions; and
determining the organization best suited to address each one of the set skill gap closure actions.

6. The method of claim 5, further comprising:
producing a detailed business case analysis addressing each one of the set of functional strategy tasks.

7. The method of claim 5, further comprising:
declaring a sourcing direction for each one of the set of functional strategy tasks.

8. The method of claim 1, wherein the organizational development structure includes an analysis of at least one of increasing the overall horizontal and vertical integration, increasing the environmental sensing capability, or increasing an organization's flexibility in areas of missions and services.

9. The method of claim 1, wherein the optimization performance structure includes an analysis of at least one of flexibility, cost, leveraging of skills and information, reliability, responsiveness, efficiency, compliancy, superior customer experience, and best of breed competitiveness.

10. The method of claim 2, wherein the skill gap closure actions include at least one of acquisition, hiring, redeployment, and skill development.

11. A computer program product comprising:
a computer usable medium including computer usable program code for optimizing a workforce for a company, the computer program product including:
computer usable program code for identifying an organizational development structure and an optimization performance structure;
computer usable program code for developing a set of functional strategy tasks using the organizational development structure and the optimization performance structure;
computer usable program code for performing an inventory of current tasks and skills within the company;
computer usable program code for identifying tasks and skills from the inventory of current tasks and skills that are associated with the set of functional strategy tasks to form a set of identified tasks and skills; and
computer usable program code for identifying a set of skill gaps using the set of identified tasks and skills.

12. The computer program product of claim 11, further including:
computer usable program code for determining a set of skill gap closure actions using the set of skill gaps; and
computer usable program code for analyzing the set of skill gap closure actions to form an analysis.

13. The computer program product of claim 12, further including:
computer usable program code for determining a set of conditions surrounding the set of skill gap closure actions;
computer usable program code for determining the capabilities of an internal or external organization to address the set of skill gap closure actions; and
computer usable program code for determining the organization best suited to address each one of the set of skill gap closure actions.

14. The computer program product of claim 13, further including:
computer usable program code for producing a detailed business case analysis addressing each one of the set of functional strategy tasks.

15. The computer program product of claim 13, further including:
computer usable program code for declaring a sourcing direction for each one of the set of functional strategy tasks.

16. A data processing system comprising:
a bus system;
a communications system connected to the bus system;
a memory connected to the bus system, wherein the memory includes a set of instructions; and
a processing unit connected to the bus system, wherein the processing unit executes the set of instructions to identify an organizational development structure and an optimization performance structure; develop a set of functional strategy tasks using the organizational development structure and the optimization performance structure; perform an inventory of current tasks and skills within the company; identify tasks and skills from the inventory of current tasks and skills that are associated with the set of functional strategy tasks to form a set of identified tasks and skills; and identify a set of skill gaps using the set of identified tasks and skills.

17. The data processing system of claim 16, wherein the data processing system executes further instructions to determine a set of skill gap closure actions using the set of skill gaps; and analyze the set of skill gap closure actions to form an analysis.

18. The data processing system of claim 17, wherein the data processing system executes further instructions to determine a set of conditions surrounding the set of skill gap closure actions; determine the capabilities of an internal or external organization to address each one of the set of skill gap closure actions; and determine the organization best suited to address each one of the skill gap closure actions.

19. The data processing system of claim 18, wherein the data processing system executes further instructions to produce a detailed business case analysis addressing each one of the set of functional strategy tasks.

20. The data processing system of claim 18, wherein the data processing system executes further instructions to declare a sourcing direction for each one of the set of functional strategy tasks.
